(19) United States
(12) Patent Application Publication
(10) Pub. No.: US 2020/0158887 A1
(43) Pub. Date: May 21, 2020

(54) DEVICE FOR ESTIMATING VEHICLE LOCATION AND METHOD FOR THE SAME

(71) Applicants: HYUNDAI MOTOR COMPANY, Seoul (KR); KIA MOTORS CORPORATION, Seoul (KR)

(72) Inventor: Sung Yong LEE, Hwaseong-si (KR)

(21) Appl. No.: 16/277,480

(22) Filed: Feb. 15, 2019

(30) Foreign Application Priority Data
Nov. 16, 2018 (KR) 10-2018-0142015

(51) Int. Cl. G01S 19/45; G01C 21/30

(52) U.S. Cl. CPC G01S 19/45; G01C 21/30

(57) ABSTRACT

A device for estimating a vehicle location includes: a location information detector configured to detect location information of a vehicle; an image information detector configured to detect vehicle-surrounding image information; and a storage configured to store a precise map. A processor is configured to determine a search region of the precise map based on a reliability of the location information, search candidate objects in the search region, match the candidate objects with the image information, and estimate a current location of the vehicle based on a matching result.

### CROSS-REFERENCE TO RELATED APPLICATION

This application claims the benefit of priority to Korean Patent Application No. 10-2018-0142015, filed in the Korean Intellectual Property Office on Nov. 16, 2018, the entire contents of which are incorporated herein by reference.

### TECHNICAL FIELD

The present disclosure relates to a device for estimating a vehicle location and a method for the same.

### BACKGROUND

An autonomous driving system needs to accurately recognize a current location of a vehicle, and therefore, a precise vehicle location estimation technique, which uses a precise map, is required. The precise map includes information such as lane information, road information, road facility information, and the like, and further, data such as sensor data, three-dimensional (3D) data, and the like are included.

Thus, as the amount of the precise map data increases, the time required to recognize the vehicle location increases due to a heavy load on a search operation of a system in a precise map search. Therefore, the conventional vehicle location estimation technique may be degraded in a performance of recognizing the vehicle location in real time as the time required for the precise map search increases.

### SUMMARY

The present disclosure has been made to solve the above-mentioned problems occurring in the prior art while advantages achieved by the prior art are maintained intact.

An aspect of the present disclosure provides a device for estimating a vehicle location and a method for the same by optimizing a precise map search region based on Global Positioning System (GPS) signal characteristics.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a device for estimating a vehicle location includes: a location information detector configured to detect location information of a vehicle; an image information detector configured to detect vehicle-surrounding image information; a storage configured to store a precise map; and a processor configured to determine a search region of the precise map based on a reliability of the location information, searching candidate objects in the search region, matching the candidate objects with the image information, and estimating a current location of the vehicle based on a matching result.

In one embodiment, the location information detector obtains the location information using a Global Positioning System (GPS) receiver.

In one embodiment, the processor is configured for generating a reference coordinate using the location information and a previous compensation value stored in the storage.

In one embodiment, the previous compensation value is defined as a difference between location information detected in a previous vehicle location estimation cycle and current estimated location information.

In one embodiment, the processor is configured for determining a search region of a predetermined shape having the reference coordinate as a center.

In one embodiment, the processor is configured for determining a size of the search region based on the reliability of the location information.

In one embodiment, the processor is configured for determining the reliability of the location information based on a horizontal dilution of precision (HDOP) calculated based on data measured by the GPS receiver.

In one embodiment, the processor is configured for determining the size of the search region based on the previous compensation value.

In one embodiment, the processor is configured for recognizing an object included in the image information, extracting a candidate object matching the recognized object from the candidate objects, calculating the current location of the vehicle based on the extracted candidate object, and defining the calculated current location as a final location.

In one embodiment, the processor is configured for calculating a difference between the final location and the location information, and for updating the previous compensation value based on the difference.

According to an aspect of the present disclosure, a method for estimating a vehicle location includes: a first operation of detecting location information and vehicle-surrounding image information of a vehicle; a second operation of generating a reference coordinate based on the location information; a third operation of determining a search region of a precise map with reference to the reference coordinate; a fourth operation of selecting candidate objects in the search region; and a fifth operation of matching the candidate objects and the image information and estimating a current location of the vehicle based on a matching result.

In one embodiment, the first operation includes detecting the location information using a Global Positioning System (GPS) module, and detecting the image information by a camera.

In one embodiment, the second operation includes generating the reference coordinate by adding a previous compensation value stored in a storage to the location information.

In one embodiment, the previous compensation value is defined as a difference between location information detected in a previous vehicle location estimation cycle and current estimated location information.

In one embodiment, the third operation includes determining a search region having a predetermined shape having the reference coordinate as a center.

In one embodiment, the third operation includes determining a size of the search region based on a signal quality of the GPS receiver, and determining the size of the search region based on the previous compensation value.

In one embodiment, the signal quality of the GPS receiver is determined based on a Horizontal Dilution Of Precision (HDOP) calculated based on data measured by the GPS receiver.

In one embodiment, the determining of the size of the search region based on the previous compensation value includes determining an expansion or reduction ratio of the search region based on the previous compensation value.

In one embodiment, the fourth operation includes recognizing an object included in the image information, extracting a candidate object matching with the recognized object from the candidate objects, calculating the current location of the vehicle based on the extracted candidate object, and defining the calculated current location as a final location.

In one embodiment, the method comprises, after the fifth operation, calculating a difference between the estimated location and the location information and updating the previous compensation value based on the difference.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a device for estimating a vehicle location according to an embodiment of the present disclosure.

FIG. 2 and FIG. 3 are exemplary diagrams for illustrating a method for determining a precise map search region according to the present disclosure.

FIG. 4 is a flow chart illustrating a method for estimating a vehicle location according to an embodiment of the present disclosure.

### DETAILED DESCRIPTION

Hereinafter, exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure relates to a vehicle location estimation (recognition) technique that may be applied to an autonomous driving system. The present disclosure sets an optimal precise map search region using a reliability of a Global Positioning System (GPS) signal, thereby enabling an efficient precise map search in an autonomous driving system.

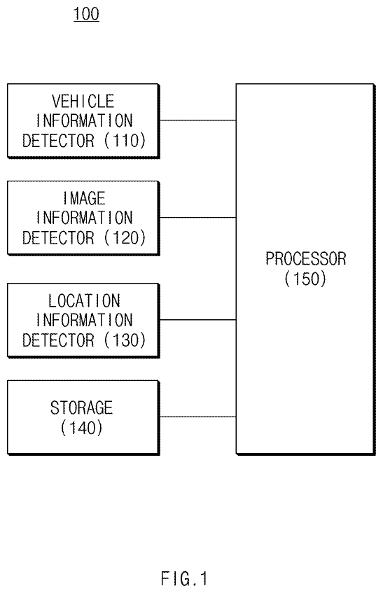

FIG. 1 is a block diagram illustrating a device 100 for estimating a vehicle location according to an embodiment of the present disclosure.

With reference to FIG. 1, the device 100 includes a vehicle information detector 110, an image information detector 120, a location information detector 130, a storage 140, and a processor 150.

The vehicle information detector 110 includes one or more sensors for detecting vehicle information and an electric control unit (ECU) mounted in a vehicle connected via an In-Vehicle Network (IVN). The IVN in the vehicle may be implemented as a Controller Area Network (CAN), a Media Oriented Systems Transport (MOST) network, a Local Interconnect Network (LIN), and/or an X-by-Wire (Flexray), or the like. The vehicle information includes vehicle drive-related control information such as a vehicle speed, a steering angle, a steering angular speed, and the like.

The image information detector 120 acquires vehicle-surrounding image information through a camera mounted on the vehicle. For example, the image information detector 120 includes the camera which can acquire a forward image of the vehicle. The image information includes objects located at the front, rear and/or side of the vehicle, a type and a distance of left and right lanes to the vehicle, a curvature of the road, and the like.

The camera may be installed at the front, the rear, and the side of the vehicle, respectively. This camera may be implemented as at least one of image sensors such as a charge coupled device (CCD) image sensor, a complementary metal oxide semiconductor (CMOS) image sensor, a charge priming device (CPD) image sensor, a charge injection device (CID) image sensor, and the like. The camera may include an image processor configured for performing an image processing such as a noise elimination, a color reproduction, a file compression, an image quality adjustment, a saturation adjustment, and the like on an image acquired through the image sensor.

The location information detector 130 measures a current location of the vehicle. The location information detector 130 may be implemented as a Global Positioning System (GPS) receiver. The GPS receiver receives signals transmitted from three or more GPS satellites, and calculates the current location of the vehicle using the received GPS signals.

In addition, the location information detector 130 calculates a horizontal dilution of precision (HDOP) based on data (location coordinate) measured by the GPS receiver. The Horizontal Dilution Of Precision (HDOP) is a coefficient indicating a degree of degradation depending on an arrangement state of the GPS satellite in the celestial sphere. The HDOP refers to an accuracy of a horizontal localization result.

The storage 140 stores precise map data (precise map information, hereinafter, referred to as a precise map). The precise map includes lane information required for an autonomous driving such as the number of the lanes, a lane location (coordinate), a road type, an appropriate speed for the road, and the like, road information, road facility information, and surroundings information.

The storage 140 may store software programmed to be embedded in the processor 150 and to perform a predetermined operation. The storage 140 may also store input and output data of the processor 150.

The storage 140 may store an image processing logic, a precise map search logic, a location estimation logic, and the like. The storage 140 may also store vehicle information, location information, image information, reference search region size, a previous compensation value, and the like. In addition, the storage 140 may also store a lookup table including information such as a search region size (range) depending on the HDOP, a search region size depending on the previous compensation value, and the like.

The storage 140 may be implemented as at least one of storage media (recording media) such as a flash memory, a hard disk, an SD card (Secure Digital Card), a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, a web storage, and the like.

The processor 150 controls an overall operation of the device for estimating a vehicle location 100. The processor 150 may be implemented as at least one of an application specific integrated circuit (ASIC), a digital signal processor (DSP), a programmable logic device (PLD), field programmable gate arrays (FPGAs), a central processing unit (CPU), microcontrollers, and microprocessors.

The processor 150 performs a vehicle location estimation logic using the information detected by the detectors 110 to 130 and the precise map stored in the storage 140 as inputs. That is, the processor 150 performs a location compensation using the location information, the image information, and the precise map information, and estimates the current location of the vehicle.

The processor 150 edits the precise map provided from the storage 140 and the vehicle information, the location information, and the image information input from the detectors 110 to 130 into data forms that may be processed at the logic. That is, the processor 150 preprocesses the data input to the logic.

The processor 150 generates a reference coordinate using the location information detected by the location information detector 130 and the previous compensation value stored in the storage 140. For example, the processor 150 calculates the reference coordinate by adding the previous compensation value to the detected location information.

In this connection, the previous compensation value is a value calculated in a previous vehicle location estimation cycle (process). The previous compensation value refers to a difference between the location information (measured location information) output from the location information detector 130 and finally estimated location information. That is, the compensation value is the estimated final location minus the location measured by the GPS receiver.

The processor 150 controls an execution of a location compensation function by optimizing the precise map search region depending on a location accuracy measured by the GPS receiver, that is a GPS signal reliability (quality). The processor 150 determines the GPS signal reliability, that is the reliability of the detected location information based on the horizontal localization result accuracy (Horizontal Dilution Of Precision, HDOP) calculated at the location information detector 130.

For example, the processor 150 determines that the GPS signal reliability is good when the HDOP is below 1, or the HDOP is 1 or above, but below 10, and determines that the GPS signal reliability is poor when the HDOP is above 10.

In addition, the processor 150 may determine the GPS signal reliability based on the previous compensation value. For example, the processor 150 determines that the GPS signal reliability is good when the previous compensation value is below 3 m, or the previous compensation value is 3 m or above, but below 9 m, and determines that the GPS signal reliability is bad when the previous compensation value is above 9 m.

The processor 150 determines the precise map search region (hereinafter, referred to as a search region) having, as a center, the reference coordinate based on the GPS signal reliability. The processor 150 maps the reference coordinate onto a precise map, and sets the search region of a predetermined shape (e.g., circle, square, polygon, or the like) having the reference coordinate as a center.

In addition, the processor 150 determines a size of the search region based on the GPS signal reliability. The processor 150 increases the size of the search region as the GPS signal reliability decreases, and decreases the size of the search region as the GPS signal reliability increases. For example, the processor 150 determines a radius of the search region based on the GPS signal reliability.

That is, the processor 150 increases or decreases the size of the search region based on the HDOP and/or the previous compensation value.

When the search region is determined, the processor 150 searches objects of the corresponding region in the precise map. At this time, the processor 150 selects one or more objects in the search region as candidate objects based on a search condition. In this connection, the search condition refers to a predetermined search object (e.g., a road sign, a lane, a subway station, and the like).

The processor 150 matches the selected candidate object with the object in the image information. That is, the processor 150 recognizes the object in the image information, and extracts the candidate object matching with the recognized object from the selected candidate objects. The processor 150 calculates the current location of the vehicle using the extracted candidate object as a reference, and defines the calculated current location as the final location.

The processor 150 calculates a difference between the estimated location information (final location) and the location information detected by the location information detector 130 as a compensation value (that is, final location-detected location). The processor 150 updates the previous compensation value stored in the storage 140 with the calculated compensation value. That is, the compensation value calculated in a current cycle is used as the previous compensation value in the next cycle.

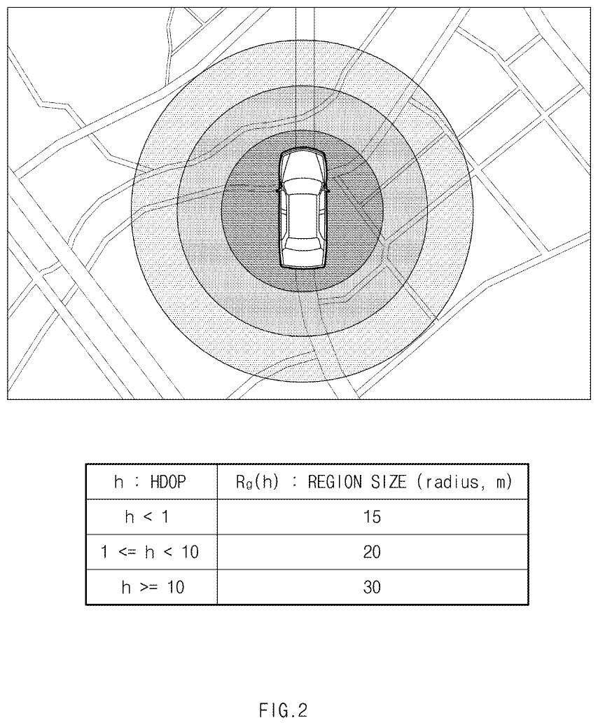

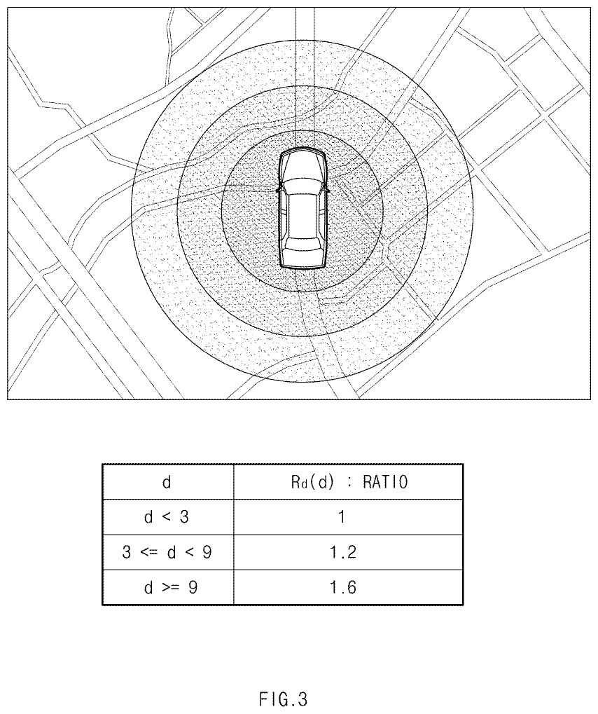

FIG. 2 and FIG. 3 are exemplary diagrams for illustrating a method for determining a precise map search region according to the present disclosure.

The processor 150 may determine the size of the search region based on the GPS signal reliability (quality). The processor 150 increases the size of the search region when the GPS signal reliability is low, and decreases the size of the search region when the GPS signal reliability is high.

In this connection, the processor 150 evaluates the GPS signal reliability (the reliability of the detected location information) using the HDOP calculated at the location information detector 130. The processor 150 determines the size R_{g}(h) of the search region depending on the HDOP h. As shown in FIG. 2, the processor 150 determines the radius R_{g} of the search region to be 15 m when the HDOP is below 1. The processor 150 determines the radius R_{g} of the search region to be 20 m when the HDOP is 1 or above, but below 10, and determines the radius R_{g} of the search region to be 30 m when the HDOP is 10 or above.

The processor 150 may determine the size of the search region based on the previous compensation value. In this connection, when the previous compensation value is large, it means that a difference between the location measured by the GPS receiver and the actual location is large. That is, when the previous compensation value is large, the location accuracy measured by the GPS receiver is low. Thus, the processor 150 increases the size R_{d}(d) of the search region when the previous compensation value d is large, and decreases the size R_{d}(d) of the search region when the previous compensation value d is small. In this connection, the size R_{d}(d) of the search region refers to a ratio (indicating an expansion or a reduction) between a current size of the search region and the reference size (reference radius) of the search region.

With reference to FIG. 3, the processor 150 determines the expansion/reduction ratio R_{d}(d) of the search region to be 1 when the previous compensation value d is below 3 m. The processor 150 determines the expansion/reduction ratio R_{d}(d) of the search region to be 1.2 when the previous compensation value d is 3 m or above, but below 9 m, and determines the expansion/reduction ratio R_{d}(d) of the search region to be 1.6 when the previous compensation value d is 9 m or above.

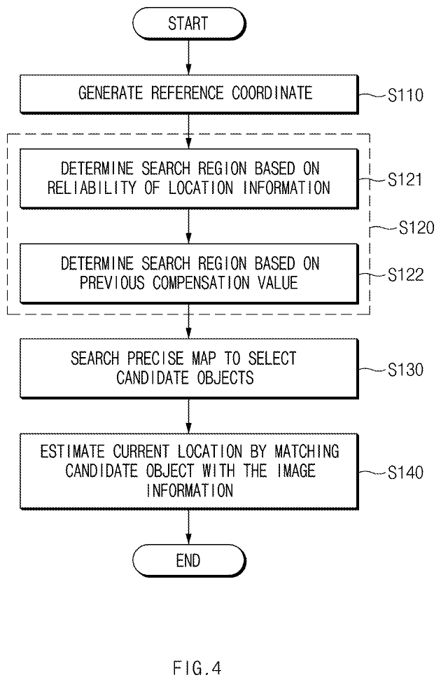

FIG. 4 is a flow chart illustrating a method for estimating a vehicle location according to an embodiment of the present disclosure.

The processor 150 of the device for estimating a vehicle location 100 generates the reference coordinate using the location information detected by the location information detector 130 and the previous compensation value stored in the storage 140 (S110). The processor 150 calculates the reference coordinate by adding the previous compensation value to the detected location information.

The processor 150 determines the precise map search region (hereinafter “search region”) based on the reference coordinate (S120). The processor 150 maps the reference coordinate on the precise map, and sets the search region having the reference coordinate as a center.

The processor 150 determines the size of the search region based on the reliability (GPS signal reliability) of the detected location information (S121). The processor 150 determines the reliability of the detected location information based on the HDOP. The processor 150 increases the size of the search region as the HDOP increases, and decreases the size of the search region as the HDOP decreases.

The processor 150 determines the size of the search region based on the previous compensation value (S122). The processor 150 increases the size of the search region when the previous compensation value is large, and decreases the size of the search region when the previous compensation value is small.

The processor 150 selects the candidate objects in the precise map based on the determined search region (S130). The processor 150 selects (classifies) the predetermined search object in the determined search region, and defines the same as the candidate objects.

The processor 150 estimates the current location of the vehicle by matching the selected candidate object with the image information detected by the image information detector 120 (S140). The processor 150 recognizes the object included in the detected image information, and extracts the candidate object matching with the recognized object among the selected candidate objects. The processor 150 calculates the current location of the vehicle using the extracted candidate object as a reference, and estimates the same as the final location.

For example, when the vehicle is traveling, the processor 150 searches for the object in the small radius region due to a good condition of the GPS signal approximately 1 HDOP and calculates the current location. Then, when the GPS signal condition deteriorates (HDOP above 10), the processor 150 increases a radius of the search region to 30 m using the operation logic. The processor 150 then checks the compensation value of the previous operation. When the previous compensation value is 10 m, the processor 150 determines that the reliability of the GPS signal is low, and then increases the search region by 60% depending on the operation logic. Thereafter, the processor 150 finally adjusts the search radius to 40 m.

In one example, when the HDOP is above 10, and the previous compensation value is above 9 m, the processor 150 sets the search region with the maximum search radius, and searches the object in the precise map to calculate the current location. Thereafter, when the vehicle deviates from the city and enters highway on a flat without a building, the GPS signal quality improves, and thus, the difference between the location measured by the GPS receiver and the estimated location becomes almost 0. Then, the processor 150 reduces the precise map search region to a minimum based on the operation logic.

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to the present disclosure, the size of the precise map search region can be varied based on the GPS (Global Positioning System) signal characteristics, therefore the precise map search region may be optimized depending on the environment. Thus, the time required to recognize the location may be optimized, and an accuracy of the vehicle location estimation may be improved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for estimating a vehicle location, the device comprising:
a location information detecting sensor configured to detect location information of a vehicle;
an image information detecting sensor configured to detect vehicle-surrounding image information;
a storage configured to store a precise map; and
a processor configured to:
determine a search region of the precise map based on a reliability of the location information;
search for candidate objects in the search region;
match the candidate objects with the image information; and
estimate a current location of the vehicle based on a matching result.

2. The device of claim 1, wherein the location information detecting sensor obtains the location information using a Global Positioning System (GPS) receiver.

3. The device of claim 2, wherein the processor is configured to generate a reference coordinate using the location information and a previous compensation value stored in the storage.

4. The device of claim 3, wherein the previous compensation value is defined as a difference between location information detected previously in previous vehicle location estimation cycle and current estimated location information.

5. The device of claim 3, wherein the processor is configured to determine a search region of a predetermined shape having the reference coordinate as a center.

6. The device of claim 3, wherein the processor is configured to determine a size of the search region based on the reliability of the location information.

7. The device of claim 6, wherein the processor is configured to determine the reliability of the location information based on a Horizontal Dilution of Precision (HDOP) calculated based on data measured by the GPS receiver.

8. The device of claim 7, wherein the processor is configured to determine the size of the search region based on the previous compensation value.

9. The device of claim 8, wherein the processor is configured to:
recognize an object included in the image information;
extract a candidate object matching the recognized object from the candidate objects;
calculate the current location of the vehicle based on the extracted candidate object; and
define the calculated current location as a final location.

10. The device of claim 9, wherein the processor is configured to calculate a difference between the final location and the location information, and to update the previous compensation value based on the difference.

11. A method for estimating a vehicle location, the method comprising:
a first operation of detecting location information and vehicle-surrounding image information of a vehicle;
a second operation of generating a reference coordinate based on the location information;
a third operation of determining a search region of a precise map with reference to the reference coordinate;
a fourth operation of selecting candidate objects in the search region; and
a fifth operation of matching the candidate objects and the image information and estimating a current location of the vehicle based on a matching result.

12. The method of claim 11, wherein the first operation includes steps of:
detecting the location information using a Global Positioning System (GPS) module; and
detecting the image information by a camera.

13. The method of claim 12, wherein the second operation includes generating the reference coordinate by adding a previous compensation value stored in a storage to the location information.

14. The method of claim 13, wherein the previous compensation value is defined as a difference between location information detected in a previous vehicle location estimation cycle and current estimated location information.

15. The method of claim 13, wherein the third operation includes determining a search region having a predetermined shape having the reference coordinate as a center.

16. The method of claim 13, wherein the third operation includes steps of:
determining a size of the search region based on a signal quality of the GPS receiver; and
determining the size of the search region based on the previous compensation value.

17. The method of claim 16, wherein the signal quality of the GPS receiver is determined based on a Horizontal Dilution of Precision (HDOP) calculated based on data measured by the GPS receiver.

18. The method of claim 16, wherein the step of determining the size of the search region based on the previous compensation value includes:
determining an expansion or reduction ratio of the search region based on the previous compensation value.

19. The method of claim 16, wherein the fourth operation includes steps of:
recognizing an object included in the image information;
extracting a candidate object matching with the recognized object from the candidate objects;
calculating the current location of the vehicle based on the extracted candidate object; and
defining the calculated current location as a final location.

20. The method of claim 13, further comprising, after the fifth operation:
calculating a difference between the estimated location and the location information; and
updating the previous compensation value based on the difference.
